(19) United States
(12) Patent Application Publication
(10) Pub. No.: US 2026/0168327 A1
(43) Pub. Date: Jun. 18, 2026

(54) LADDER STABILISING SYSTEM

(71) Applicant: SHARED ASCENT PTY LTD, DONVALE (AU)

(72) Inventors: Jeremy MCARTHUR, Prahran (AU); Clare MCARTHUR, Prahran (AU)

(73) Assignee: SHARED ASCENT PTY LTD, DONVALE (AU)

(21) Appl. No.: 19/121,588

(22) PCT Filed: Sep. 29, 2023
(86) PCT No.: PCT/AU2023/050944

§ 371 Date: Apr. 16, 2025

(30) Foreign Application Priority Data
Oct. 18, 2022 (AU) 2022256111

(51) Int. Cl. E06C 7/44; E06C 1/06; E06C 7/42

(52) U.S. Cl. CPC E06C 7/44; E06C 7/423; E06C 1/06

(57) ABSTRACT

A stabilising system for a ladder comprising two pairs of legs which are slidably and rotationally attached to a ladder's stiles, allowing them to be deployed on uneven surfaces. The four legs sit well fore and aft of and away from the ladders feet to give a large footprint that prevents the ladder from tipping sideways or backwards, or sliding forwards.

### FIELD OF THE INVENTION

The present invention relates to ladders and in particular a stabilising system that allows the use of a ladder on even and uneven surfaces and prevents unwanted fore, aft or sideways movement.

### BACKGROUND TO THE INVENTION

Ladders are a convenient tool that allow users to easily reach a height, and have a long and widespread history of use throughout the world in private and workplace settings. Whilst simple and effective, ladders can be dangerous to use and many accidents and even deaths in relation to ladder usage are reported every year. Many workplaces have recognised the dangers of ladder usage and mandate that a ladder can only be used where there is a second person present to ensure stability of the ladder, with the obvious inconvenience and labour costs incurred.

In its simplest form a ladder comprises a pair of stiles with a series of spaced apart rungs in between. In use a ladder is leant against a vertical wall, with an accepted optimal safe angle being 75.5 degrees to the horizontal. A lesser angle increases the risk of the ladder falling backwards and a greater angle increases the chance of the feet slipping.

A normal ladder should only be used on flat ground to prevent the ladder tipping sideways, and on a surface that provides suitable friction to prevent the feet of the ladder from slipping. When using a ladder, a user must take care not to reach too far sideways nor backwards to ensure that the ladder does not tip over. Many users are tempted to operate outside of the ideal placement and usage and suffer the consequences.

Ideally a ladder should be stabilised sideways, fore and aft, be suitable for use on uneven surfaces of any composition and not require separate fixings. Many attempts have been made over the years to improve the stability of ladders, but have not successfully addressed all issues. A stabilising method should also be easy to use and add minimal cost and bulk to a ladder.

A first known stability aid is to rigidly attach the ladder to the ground with a stake, directly as disclosed in patent publication US201000051384A1, or via an intermediate platform or the like such as disclosed in patent publication US20130119213A1. These aids are not suitable for uneven ground or hard surface where the stake cannot penetrate

A second stability aid is to tie the ladder to a wall with the aid of anchor points. Whilst an effective stability aid it is time consuming to use and permanently impacts the structure to which it is attached.

Many ladders come with the bottom portion of the stiles splayed. This helps to reduce the chance of a ladder tipping sideways, but permanently increases the width of the ladders making them troublesome to store, and does not address uneven surfaces nor unwanted fore and aft movement.

A simple stability aid is to increase the size of the feet as in patent publication EP2569502B1. This helps with slipping but doesn't address tipping and is unsuitable for uneven surfaces.

Another known aid is a platform or base plate as per patent publications U.S. Pat. No. 5,078,231A and US20160053539A1. These are bulky for storage and unsuitable for use on uneven ground.

Leg extensions are known for overcoming uneven ground such as in patent publications JP2013510251A and US20050092551A1, however they do not address tipping over.

Stabilising aids incorporating arms attached to a ladder have been seen in patent publications U.S. Pat. No. 6,672,427B1, US20070158138A1, US20080314682A1 and U.S. Pat. No. 8,607,932B2. These solutions are either excessively bulky, cumbersome to use, rely on legs being attached to the ground, are unsuitable for use on uneven ground, or do not prevent tipping in all directions.

Further examples of stabilising aids are known from GB2042041A, GB2146688A, U.S. Pat. Nos. 4,519,477A, 4,632,220A and 3,012,628A which comprise arms/legs attached to either stile. Whilst offering some improvement, these devices still rely on use of the legs of the ladder being in contact with the ground and hence are unsuitable for use on uneven terrain.

Whilst the various prior art devices have addressed many of the problems, no single aid address all the problems simultaneously.

The object of this invention is to provide a stabilising system for a ladder to alleviate the above problems, or at least provide the public with a useful alternative.

### SUMMARY OF THE INVENTION

In a first aspect the invention provides a stabilising system for a ladder comprising two pairs of legs, each leg with a proximal end and a distal end, wherein the proximal ends of the legs are attached to a leg mounting assembly which is slidably and rotationally attached to a stile of the ladder, and wherein the distal ends of the legs are unrestrained to provide spaced apart points of contact with a surface.

The pairs of legs are preferably attached to a stile of the ladder via a leg mounting assembly operable between an unlocked configuration in which it can slide and rotate with respect to the stile, and a locked configuration in which it cannot slide and rotate with respect to the stile.

The stiles preferably comprise a guide rail with a cylindrical cavity accessible via an aligned guide slot, and the leg mounting assembly comprises a guide ball mounted on a stem, wherein the guide slot is sized to retain the guide ball within the cylindrical cavity and the stem sits within the guide slot.

In preference the guide ball rotates within the cylindrical cavity to effect rotation of the legs, and slides within the cylindrical cavity to effect translation of the legs.

Preferably the leg mounting assembly further comprises a first handle with a locking chamber holding a locking bar attached to the guide ball via a first stem, and a second handle hingedly attached to second stems attached to the locking bar, and wherein rotation of the second handle draws the locking bar in contact with an inner surface of the locking chamber and draws the first handle in contact with the stile to effect the locked configuration.

The first handle preferably comprises a first stem slot accommodating the first stem and second stem slots accommodating the second stems to allow rotation of the locking bar within the locking chamber to effect splaying of the legs.

Preferably the guide rails further comprise a second guide slot disposed perpendicular to the first guide slot to allow rotation of the pairs of legs to a position behind the ladder.

In preference the pairs of legs comprise a first leg and a second leg disposed non-collinearly.

The guide rails may be integrally formed with the stiles.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows a ladder fitted with a stabilising system according to a preferred embodiment of the invention wherein the legs of the stabilising system are deployed to compensate for an uneven surface.

FIG. 2A shows a front perspective view of the ladder with the stabilising system stowed, whilst FIG. 2B shows a rear perspective view.

FIG. 3 shows a ladder with the right stabilising system in a first stage of deployment.

FIG. 4 shows a ladder with the stabilising system in a second stage of deployment.

FIG. 5A shows a perspective view of a ladder with the stabilising system fully deployed on a flat surface, whilst FIG. 5B shows a front orthogonal view and FIG. 5C shows a front orthogonal view with the right-hand legs further splayed.

FIG. 6 shows a close-up view of a leg mounting assembly and a pair of legs of the stabilising system in a locked configuration.

FIGS. 7A and 7B show a first and second close-up perspective view of a leg mounting assembly in a locked configuration. FIG. 7C shows the same view as FIG. 7B but with the fixed handle hidden. FIG. 7D shows a close-up perspective view of the leg mounting assembly in an unlocked configuration.

FIG. 8 shows a close-up partial view of a guide rail of the stabilising system.

FIG. 9A shows a side view of a leg mounting assembly fully splayed and in an unlocked configuration with a cut-away view of a guide rail, whilst FIG. 9B shows the same but with the leg mounting assembly in a locked configuration. FIG. 9C shows the leg mounting assembly in a locked configuration, but splayed less than in FIG. 9B.

### DRAWING INTEGERS

The drawings include the following integers.
10 surface
11 first prominence
12 second prominence
15 gap
20 ladder
21 stiles
22 rungs
30 stabilising system
40 guide rails
42 cylindrical cavity
44 guide slot
46 perpendicular slot
50, 50′ legs
60 leg mounting assembly
62 fixed handle
64 locking chamber
66 ball stem slot
68 handle stem slots
70 locking bar
72 handle stems
74 guide ball stem
76 guide ball
78 handle shaft
80 movable handle
82 thin side
84 thick side
88, 89 gaps

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The present invention provides a stabilising system to prevent a ladder from tipping sideways, fore or aft, and allows the ladder to be used on even and uneven surfaces. The system comprises two pairs of legs to provide a much-increased footprint for a ladder and hence stability. The legs are slidably and rotationally attached to the ladder stiles, allowing them to be deployed on uneven surfaces and to be compactly stowed away when not in use.

The stabilising system of the invention comprises identical components fitted to either stile of a ladder. The following description will largely describe the system in the sense of a first half of the system fitted to one of the stiles. It is to be understood that the second half of the system is identical in form and function to the first half of the system and that the two halves operate independently of each other. Either or both halves of the system may be deployed, and they may be deployed differently depending on the surface topography.

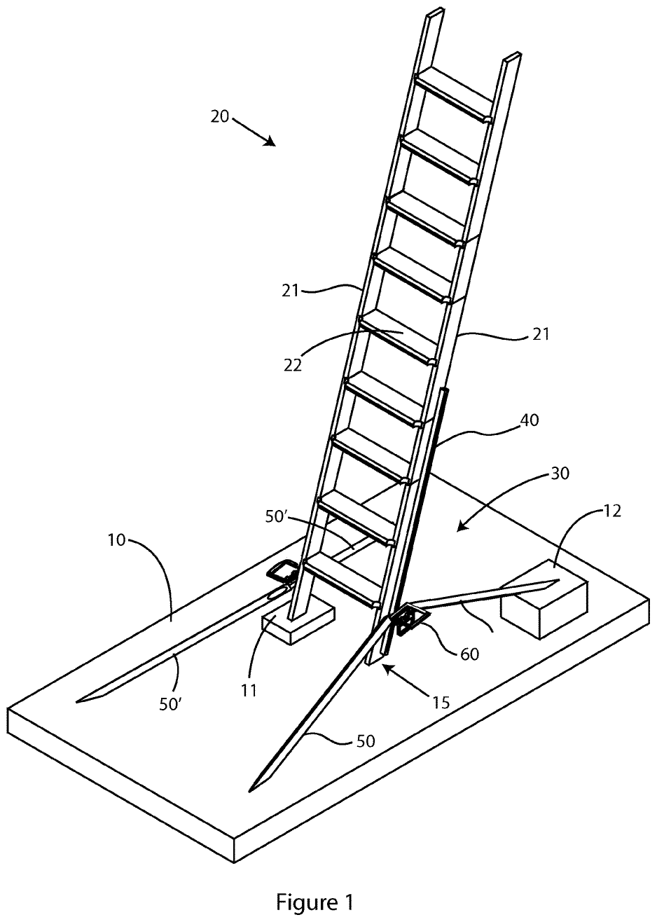

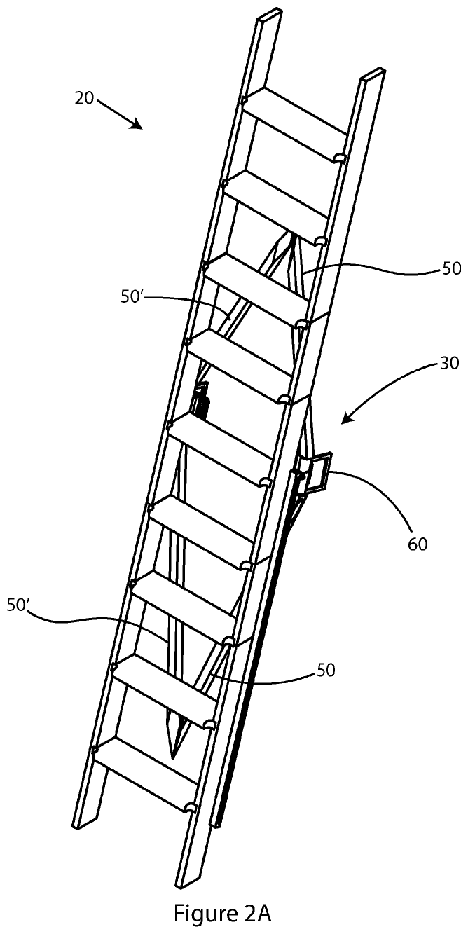

A ladder 20 fitted with a stabilising system 30 according to a preferred embodiment of the invention is shown in FIG. 1 deployed on a surface 10 which has been made uneven by a first prominence 11 and a second prominence 12. The stabilising system 30 comprises a guide rail 40 to which a pair of legs 50 are rotatably and slidably attached via leg mounting assembly 60 which allows for manipulation of the legs and locking them in position. The legs are fixedly attached to the leg mounting assembly and not collinear but disposed at an angle of approximately 135 degrees to each other so that the ends of both legs can be placed on an uneven surface. FIG. 1 represents a challenging scenario for the system in which one of the ladder stiles is sat upon the first prominence 11, and one of the legs of the stabilising system is sat upon the second prominence 12. Despite the uneven topography the ladder is able to be held in an optimal position without any sideways lean. One of the ladders stiles is even suspended in the air as indicated by gap 15. The system is able to handle even more challenging scenarios in which both stiles are suspended off of the ground, and each of the legs of the system is sitting on a different height prominence or depression. As the ladder can be suspended in the air by the stabilising system itself, it is even possible to use the ladder without anything to lean against, allowing a single ladder to be used where a trestle ladder would normally be required.

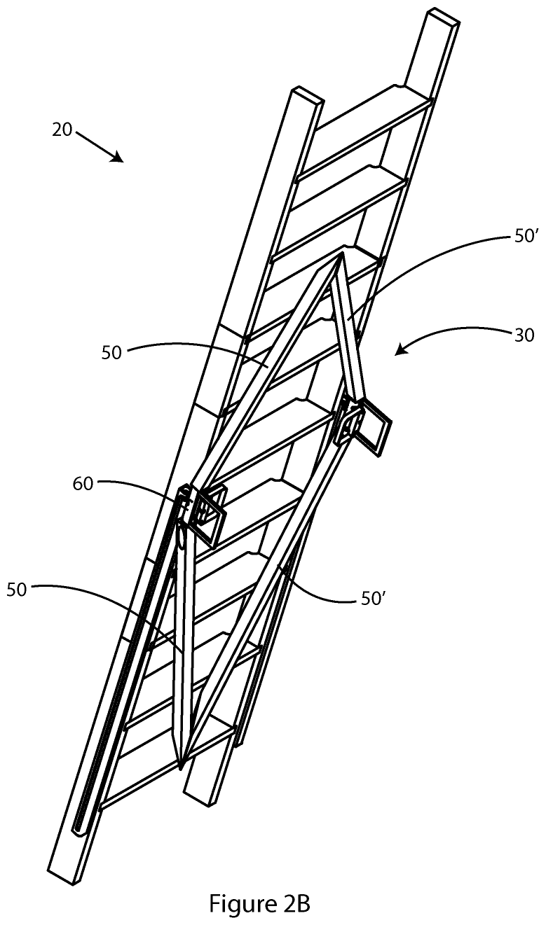

FIGS. 2 to 5 show the sequence of deploying the stabilising system.

FIGS. 2A and 2B show front and rear perspective views of a ladder 20 with the stabilising system 30 stowed away. The pairs of legs 50 are positioned against the rear of the ladder providing for compact storage, whilst still allowing the ladder to be used in a normal fashion.

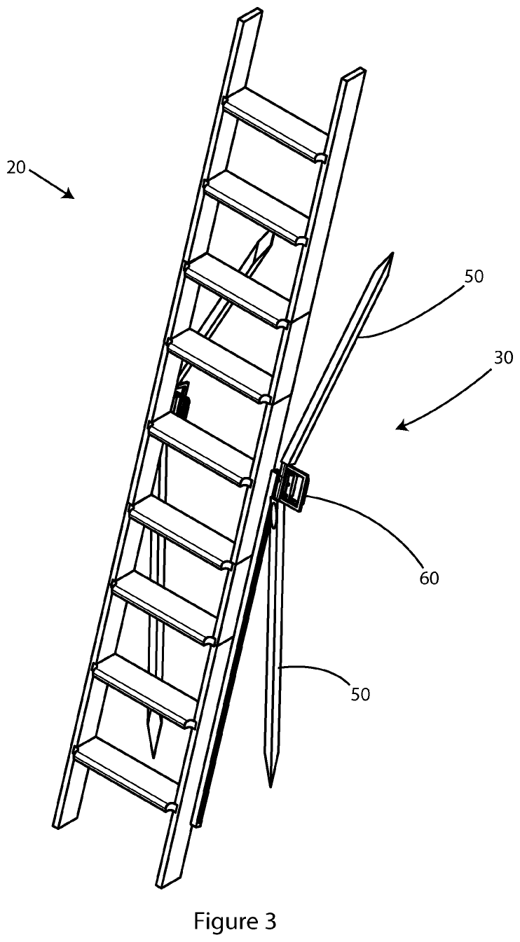

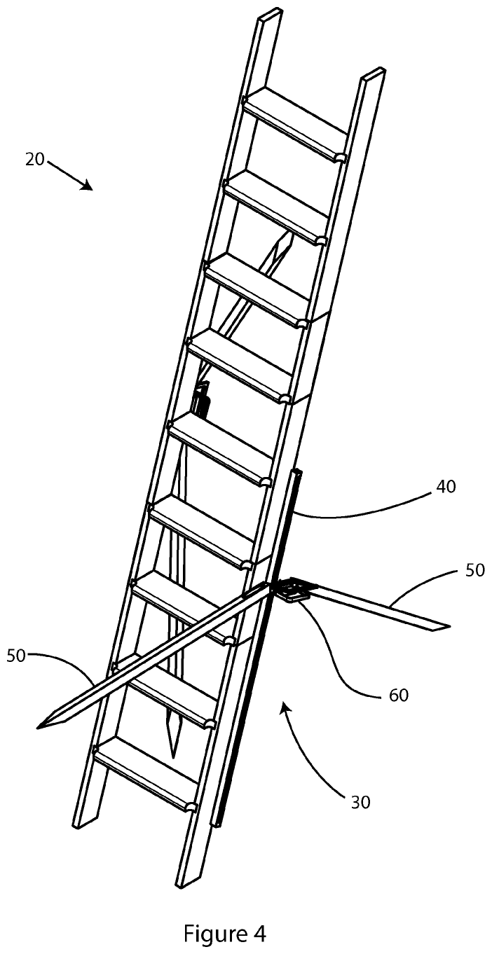

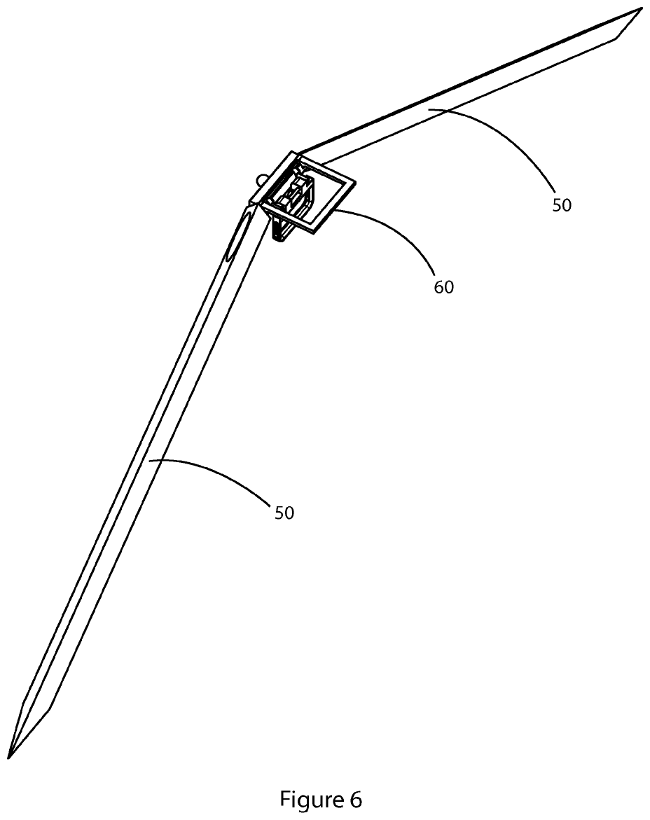

FIG. 3 shows a ladder 20 with the stabilising system 30 in a first stage of deployment. The leg mounting assembly 60, details of which are described below with the aid of FIGS. 6 to 11, is unlocked and used to rotate the pair of legs 50 outwards from behind the ladder.

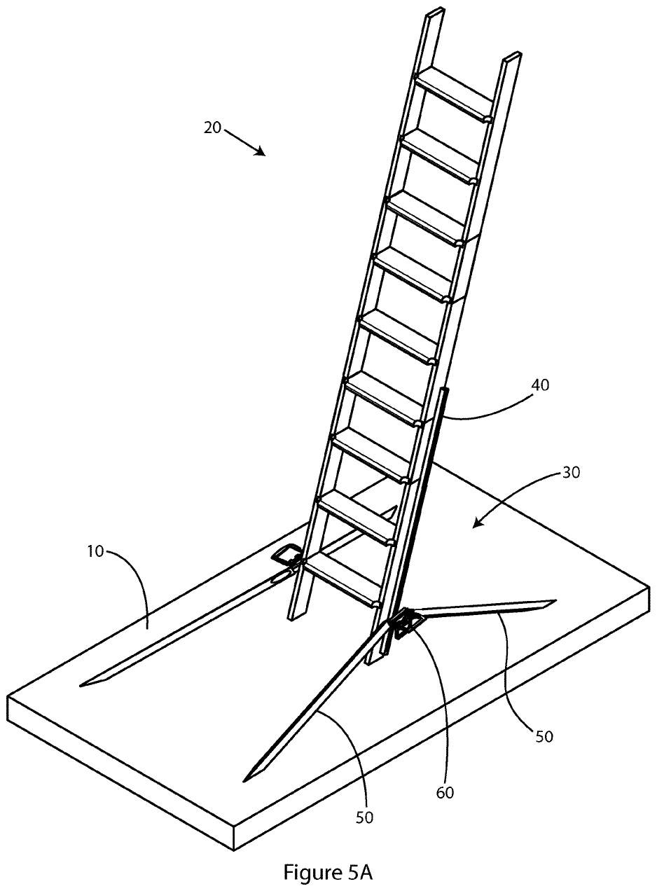

In FIG. 4 the stabilising system 30 is shown in a second stage of deployment in which the leg mounting assembly 60 has been used to rotate the pair of legs 50 to a roughly horizontal position and slide the pair of legs part way down the guide rail 40.

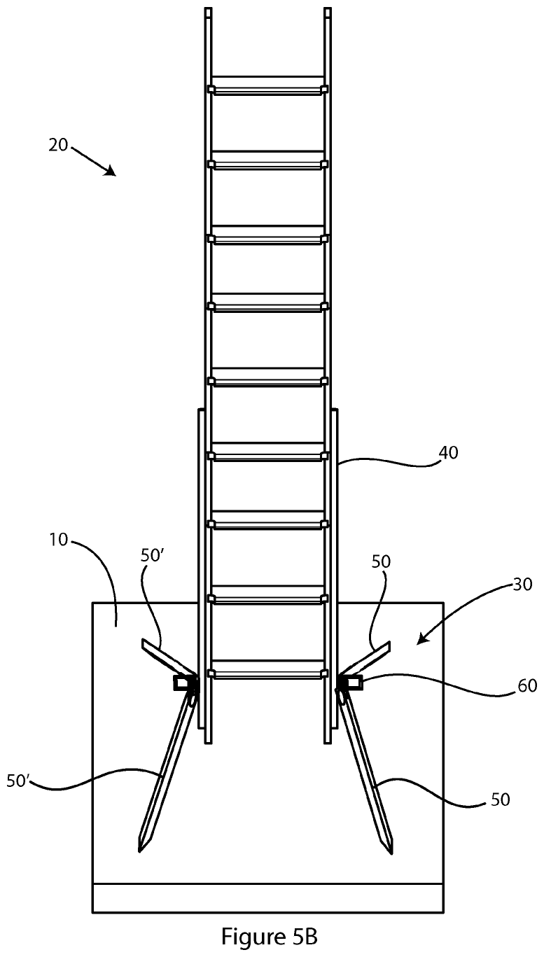

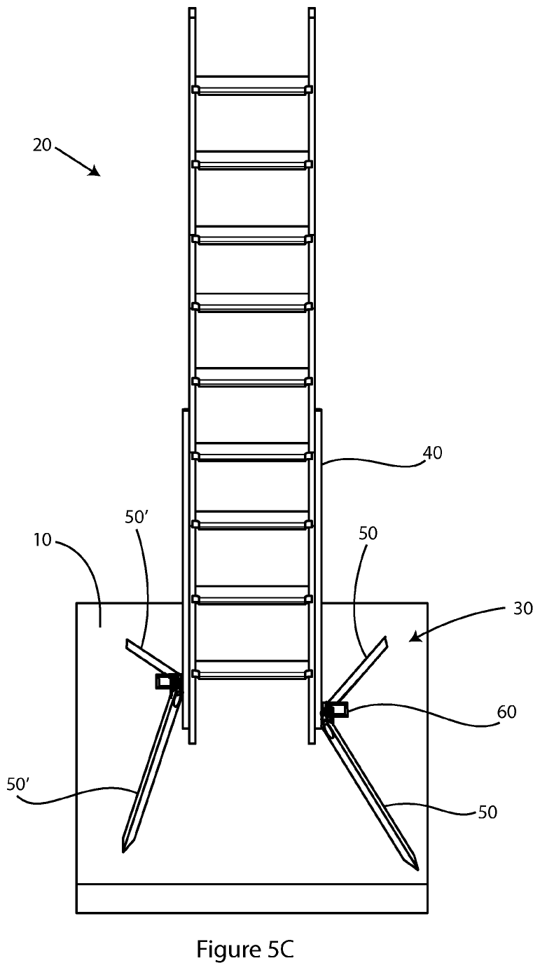

In FIG. 5A the stabilising system has been fully deployed with the pairs of legs 50, 50′ deployed on to surface 10. The ladder 20 has now been stabilised with the pairs of legs effectively providing a large footprint for the ladder, preventing it from tipping fore, aft or sideways. FIG. 5A provides a perspective view whilst FIG. 5B provides a front orthogonal view of the stabilising system fully deployed. FIGS. 5A and 5B shows the legs in a nominal deployed position. In FIG. 5C the right-hand pair of legs 50 have been splayed further than the left-hand legs 50′, giving a wider and more stable base. The left-hand legs 50′ may be splayed further in the same manner.

The leg mounting assembly 60 can either lock the pair of legs 50 in a desired position or let them rotate to a new position using a ball and socket joint. This allows the pairs of legs to move from the stowed position to a fully deployed position on a wide range of surface topographies and vice versa. FIGS. 6 to 11 show close-up views of the leg mounting assembly in locked and unlocked configurations and its components in isolation.

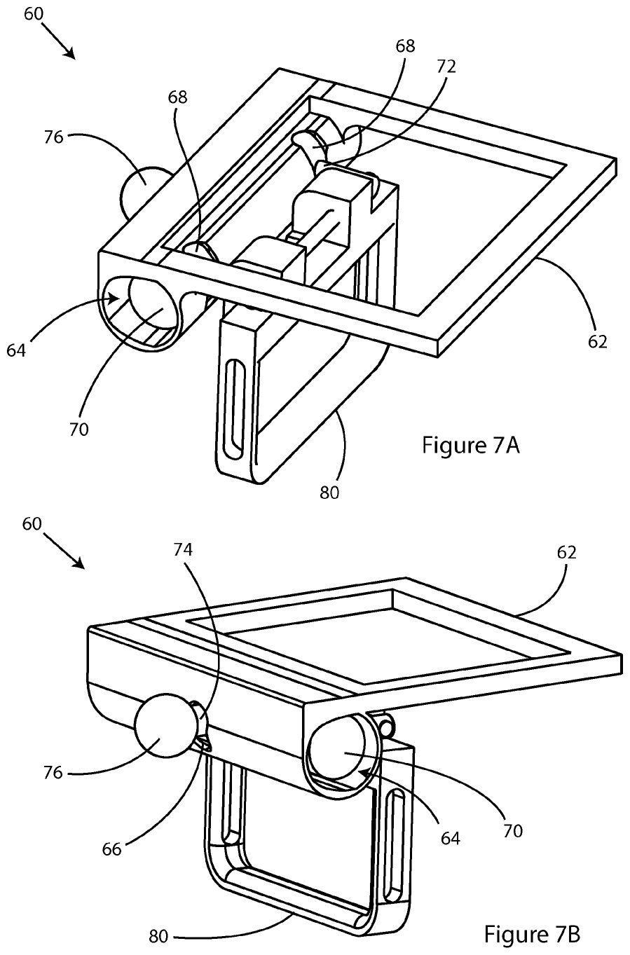

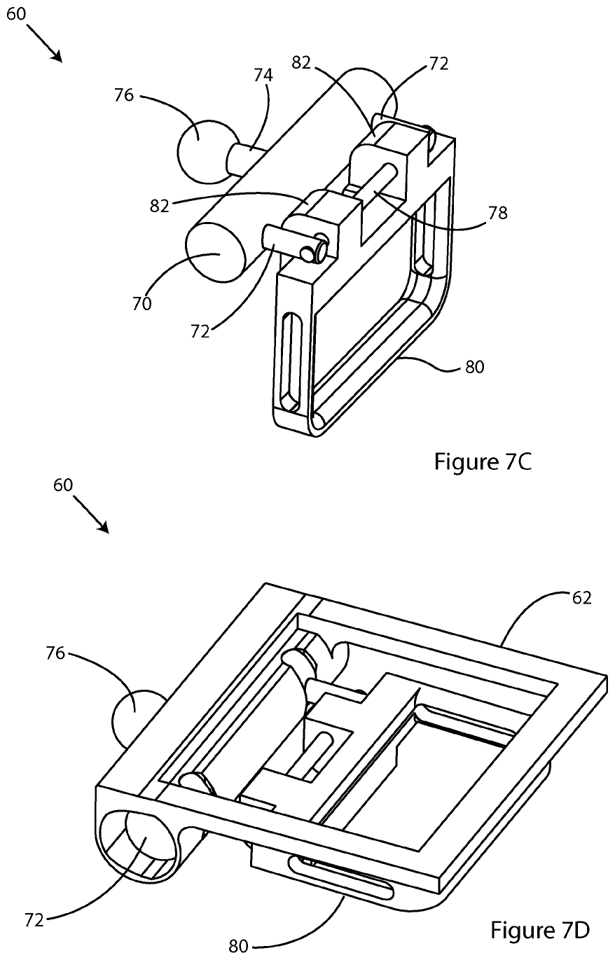

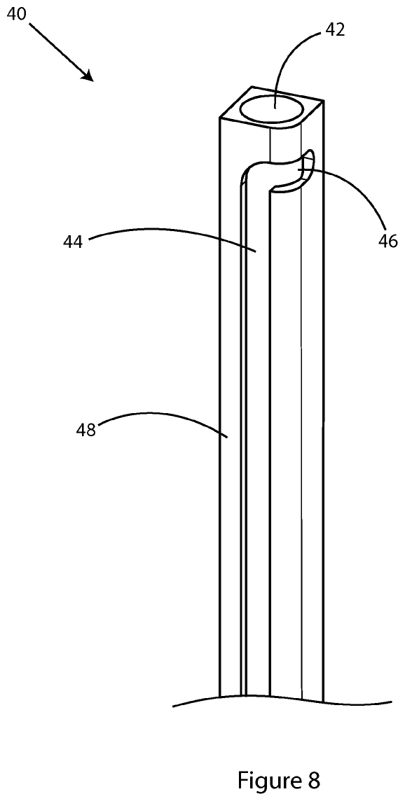

In FIG. 6 a leg mounting assembly 60 with legs 50 attached is seen in a locked configuration. The leg mounting assembly 60 is shown in isolation in FIG. 7A to 7D and comprises a fixed handle 62 for manipulating the position of the legs, and a moving handle 80 which is used to move the leg mounting assembly between the locked and unlocked configurations. The moving handle 80 is perpendicular to the fixed handle in the locked configuration (FIGS. 7A, 7B and 7D) and parallel to it in the unlocked configuration (FIG. 7D). The fixed handle 62 includes locking chamber 64 in which sits locking bar 70. The form of the locking bar is best appreciated from FIG. 7C where the fixed handle has been hidden. The locking bar has handle stems 72 emanating from a first side to which the moving handle 80 is pivotally attached at their distal ends, and emanating from a second side is guide ball stem 74 with guide ball 76 at its distal end. The guide ball 76 sits within a cylindrical cavity 42 of a guide rail 40 as seen in close-up in FIG. 8. The guide ball can rotate and slide up and down in the cavity, conveying the same motion to the leg mounting assembly and attached legs. The guide slot 44 is aligned with and provides access to the cavity 42, and is sized to accommodate the guide ball mount, but still retain the guide ball in the cavity. At the top of the guide rail the guide slot is closed to ensure that the guide ball doesn't escape. A perpendicular slot 46 towards the top of the guide slot allows the legs to be stowed to and unstowed from behind the ladder as illustrated in FIG. 2A (stowed) and FIG. 3 (unstowed). The guide rails shown are separate component attached to the stiles. In an alternative embodiment of the invention, not shown, the guide rails are integrally formed with the stiles.

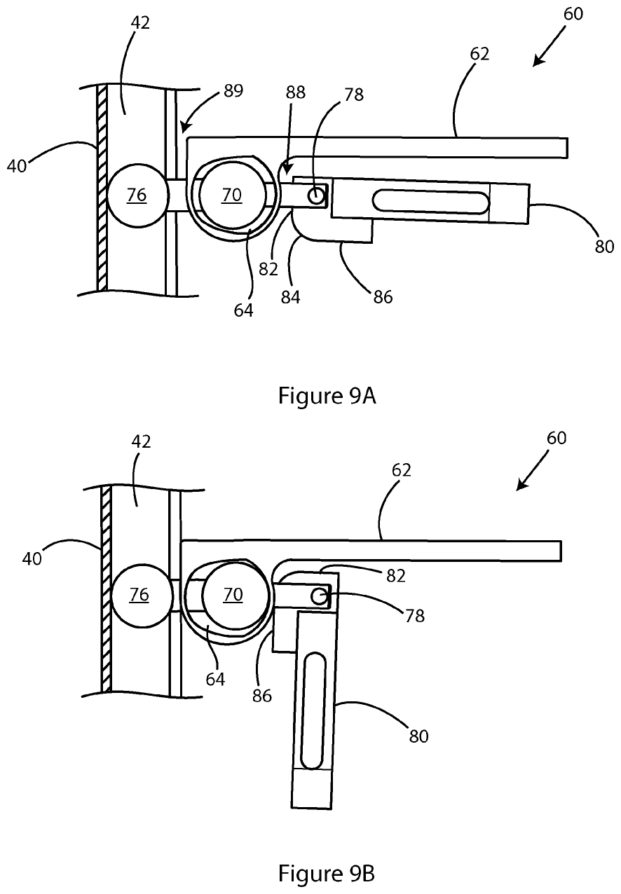

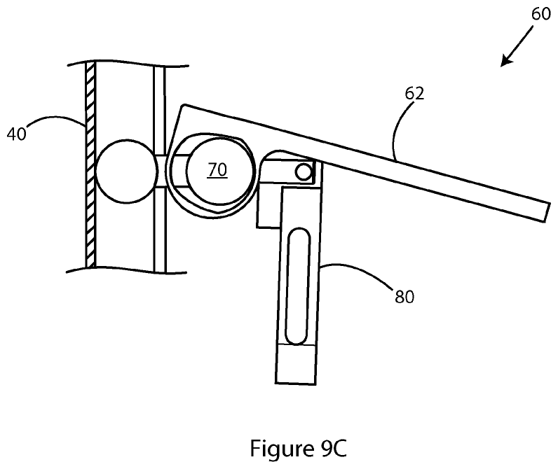

Locking and unlocking of the leg mounting assembly 60 is best appreciated with FIGS. 9A and 9B which show a side view of an unlocked configuration and a locked configuration respectively. Moving between the unlocked and locked configurations is effected by the movable handle 80 and its different width sides 82 and 86 adjacent handle shaft 70 about which the movable handle rotates. In the unlocked configuration the thin side 82 of the movable handle allows a gap 88 between the movable handle and the fixed handle 64, and a gap 89 between the fixed handle and the guide rail 40. The mounting assembly 60 is thus free to move up and down and rotate, imparting the same movement to the legs 50. To move to the locked configuration the movable handle is rotated clockwise, bringing the thick side 86 in contact with the fixed handle eliminating gap 88 and also pushing the fixed handle to the left until it comes in contact with the guide rail 40 eliminating gap 89. The movable handle 80 is held tightly against the fixed handle which in turn is held tightly against the guide rail, preventing movement of the mounting assembly 60 and likewise preventing movement of the legs 50. To return to the unlocked configuration the movable handle is rotated clockwise.

As discussed previously with reference to FIGS. 5B and 5C, the legs 50 are capable of being splayed outwards to varying degree by manipulation of the leg mounting assembly 60 attached to the legs. The fixed handle 62 rotates about the locking bar 70. Handle stem slots 72 provide clearance for the handle stems 72 during rotation, likewise, guide ball stem slot 66 provides clearance for guide ball stem 74. FIG. 9B shows the leg mounting assembly locked and in a fully splayed position corresponding to FIG. 5C whilst FIG. 9C shows a less splayed position corresponding to FIG. 5B. The legs can be locked with any degree of splaying. Normally it would be preferable to have the legs fully splayed to maximise stability, and where room does not permit, less splayed. The splaying mechanism also aids in stowing the legs flat against the back of the ladder as seen in FIG. 2A.

The above disclosure has described a ladder stabilising system that can simultaneously address all ladder stability issues, i.e. tipping backwards, sliding and tipping forwards, tipping sideways and overcoming uneven surfaces. The two pairs of legs of the system provide a much-increased footprint for a ladder and hence stability. The legs are slidably and rotationally attached to the ladder stiles, providing for quick and simple deployment, easy adaption to uneven surfaces and can be compactly stowed away when not in use.

1. A stabilising system for a ladder comprising:
two pairs of legs, each leg with a proximal end and a distal end;
wherein the proximal ends of the legs are attached to a leg mounting assembly which is slidably and rotationally attached to a stile of the ladder; and
wherein the distal ends of the legs are unrestrained to provide spaced apart points of contact with a surface.

2. The stabilising system as in claim 1, wherein the leg mounting assembly is operable between an unlocked configuration in which it can slide and rotate with respect to the stile, and a locked configuration in which it cannot slide and rotate with respect to the stile.

3. The stabilising system as in claim 1, further comprising:
at least one stile located on the ladder;
wherein the at least one stile comprise:
a guide rail with a cylindrical cavity accessible via an aligned guide slot;
wherein the leg mounting assembly comprises:
a guide ball mounted on a stem; and
wherein the guide slot is sized to retain the guide ball within the cylindrical cavity and the stem sits within the guide slot.

4. The stabilising system as in claim 3, wherein the guide ball rotates within the cylindrical cavity to effect rotation of the legs.

5. The stabilising system as in claim 3, wherein the guide ball slides within the cylindrical cavity to effect translation of the legs.

6. The stabilising system as in claim 3, wherein the leg mounting assembly further comprises:
a first handle with a locking chamber holding a locking bar attached to the guide ball via a first stem;
a second handle hingedly attached to second stems attached to the locking; and
wherein rotation of the second handle draws the locking bar in contact with an inner surface of the locking chamber and draws the first handle in contact with the stile to effect the locked configuration.

7. The stabilising system as in claim 6, wherein the first handle further comprises a first stem slot accommodating the first stem and second stem slots accommodating the second stems to allow rotation of the locking bar within the locking chamber to effect splaying of the legs.

8. The stabilising system as in claim 3, wherein the guide rails further comprise a second guide slot disposed perpendicular to the first guide slot to allow rotation of the pairs of legs to a position behind the ladder.

9. The stabilising system as in claim 1, wherein each of the two pairs of legs comprise a first leg and a second leg disposed non-collinearly.

10. The stabilizing system as in claim 1, further comprising:
at least one stile located on the ladder; and
at least one guide rails integrally formed with the at least one stile.
